(19) United States
(12) Patent Application Publication
(10) Pub. No.: US 2026/0350375 A1
(43) Pub. Date: Nov. 5, 2026

(54) ARTIFICIAL INTELLIGENCE MODEL QUANTIZATION METHOD AND SYSTEM

(71) Applicant: SAMSUNG SDS CO., LTD., Seoul (KR)

(72) Inventors: Ji Eun CHOI, Seoul (KR); Dae Hyeon BAEK, Seoul (KR); Ji Myoung SON, Seoul (KR); Hyo Jung LEE, Seoul (KR)

(73) Assignee: SAMSUNG SDS CO., LTD., Seoul (KR)

(21) Appl. No.: 19/348,247

(22) Filed: Oct. 2, 2025

(30) Foreign Application Priority Data
Apr. 28, 2025 (KR) 10-2025-0055213

(51) Int. Cl. G06N 3/0495; G06N 3/048

(52) U.S. Cl. CPC G06N 3/0495; G06N 3/048

(57) ABSTRACT

Provided is an artificial intelligence (AI) model quantization method. The quantization method according to an embodiment may include: obtaining an input activation matrix X and a weight matrix W of an AI model; sequentially multiplying the obtained input activation matrix X by a permutation matrix P and a smoothing matrix T and obtaining a transformed input activation matrix \tilde{X} as a result of the matrix multiplication operation; sequentially multiplying an inverse matrix T⁻¹ of the smoothing matrix, an inverse matrix P⁻¹ of the permutation matrix and the weight matrix W and obtaining a transformed weight matrix \tilde{W} as a result of the matrix multiplication operation; quantizing the transformed input activation matrix \tilde{X}; quantizing the transformed weight matrix \tilde{W}; and multiplying the quantized transformed input activation matrix by the quantized transformed weight matrix to output a quantized linear transform result of the AI model.

This application claims the benefit of Korean Patent Application No. 10-2025-0055213, filed on Apr. 28, 2025, in the Korean Intellectual Property Office, the disclosure of which is incorporated herein in its entirety by reference.

### BACKGROUND

### 1. Field

The present disclosure relates to an artificial intelligence (AI) model quantization method and system, and more particularly, to an AI model quantization method and system which mitigate the problem of degradation of quantization performance caused by outliers.

### 2. Description of the Related Art

A technology for quantizing an artificial intelligence (AI) model is provided. The quantization technology is a technology that reduces computational speed and memory usage by reducing the precision of an AI model. For example, a deep learning model trained in 32-bit floating point (FP32) format may be converted to a lower precision such as an 8-bit integer (INT8) to obtain effects such as improving computational speed, reducing memory usage, and reducing power consumption.

When the quantization technology is applied, if a weight outlier or an activation outlier exists in a target AI model, there may be a problem with the quantization result. For example, most weights are concentrated between −0.1 and 0.1. However, if one of the weights is 5.0, the outlier weight having a value of 5.0 will significantly expand a dynamic range for quantization to accommodate the outlier. This will compress most weights into a narrow range. As a result, most weights will be converted into the same integer. An AI model quantized in this way will have difficulty in performing to its full potential.

As solutions to the outlier problem in quantization, various techniques have been proposed. The techniques include clipping which is a technique of cutting out outliers exceeding a certain threshold; outlier-aware quantization which is a technique of storing only outliers separately or keeping the outliers floating and quantizing only the rest; per-channel quantization; quantization-aware training (QAT) which is a technique of mimicking quantization during a training phase to make a model adapt to outliers; SmoothQuant which is a technique of reducing activation outliers and increasing quantization efficiency by smoothing a scale between activations and weights; and activation-aware weight quantization (AWQ) which is a technique of optimizing quantization using statistical information of activations.

However, the above-described solutions to the outlier problem perform quantization by uniformly scaling outliers without distinguishing between the outliers according to the type of outlier. In the case of a channel where extreme outliers exist, since the extreme outliers are distributed in very small numbers, the existing outlier problem solutions, which mitigate channel-wise outliers using only one scaling factor, cannot sufficiently mitigate the extreme outliers.

### SUMMARY

Aspects of embodiments of the present disclosure provide an artificial intelligence (AI) model quantization method and system which quantize an AI model while suppressing an increase in quantization error even when extreme outliers, which are extreme compared to general outliers, are included in an input activation channel.

Aspects of embodiments of the present disclosure also provide an AI model quantization method and system which minimize accuracy loss through a different smoothing process for extreme outliers and general outliers.

Aspects of embodiments of the present disclosure also provide an AI model quantization method and system which minimize accuracy loss through different smoothing processes for extreme outliers and general outliers.

Aspects of embodiments of the present disclosure also provide an AI model quantization method and system which automatically distinguish between extreme outliers and general outliers based on element values of an input activation matrix.

Aspects of embodiments of the present disclosure also provide an AI model quantization method and system which automatically distinguish between extreme outliers and general outliers based on element values of a weight matrix of an AI model.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of the present disclosure, there is provided an AI model quantization method including: obtaining an input activation matrix X and a weight matrix W of an AI model; sequentially multiplying the obtained input activation matrix X by a permutation matrix P and a smoothing matrix T and obtaining a transformed input activation matrix [symbol] as a result of the matrix multiplication operation; sequentially multiplying an inverse matrix T⁻¹ of the smoothing matrix, an inverse matrix P⁻¹ of the permutation matrix and the weight matrix W and obtaining a transformed weight matrix [symbol] as a result of the matrix multiplication operation; quantizing the transformed input activation matrix [symbol] ; quantizing the transformed weight matrix [symbol] ; and multiplying the quantized transformed input activation matrix by the quantized transformed weight matrix to output a quantized linear transform result of the AI model. The permutation matrix may be a permutation matrix that rearranges columns of extreme outliers, which satisfy a predetermined definition of extreme outliers, among columns of the input activation matrix X to predesignated positions, the smoothing matrix may include a first sub-matrix composed of elements of the smoothing matrix multiplied by the rearranged columns of extreme outliers, and the first sub-matrix may be a lower triangular matrix.

In an embodiment, the permutation matrix may be a permutation matrix that rearranges the columns of the input activation matrix X in descending sorted order based on a (maximum element value/mean element value) of each column. The permutation matrix may be a permutation matrix that rearranges only top N columns among the columns of the input activation matrix X in descending sorted order based on the (maximum element value/mean element value) of each column. The top N columns may be top N columns whose maximum element values are large among the columns of the input activation matrix X.

The predetermined definition of extreme outliers may be [columns 1 to N* of an input matrix rearranged in descending sorted order], wherein N* is a first j (j>=1) that satisfies the following equation:

(Maximum element value/mean element value) of column j/(maximum element value/mean element value) of column (j+1)<=reference value.

The first sub-matrix may include a first smoothing factor sⱼₖ (k<=j<=N*) at position (row j, column k) which is determined in consideration of both a maximum value and a mean value of each of columns 1 to N* of the transformed input activation matrix, wherein N* is an index of a last extreme outlier among columns of an input matrix rearranged in descending sorted order.

The first smoothing factor sⱼₖ may be a value that satisfies the following equation for calibration data of the input activation matrix X:

sⱼₖ=max(|zⱼ|)^{α}mean(|zⱼ|)^{β}, for k≤j≤N*, where(α,β)∈[0,1]×[0,1] and 0<α+β<1 s.t. min∥X− [symbol] ∥,(X is the quantization result of X)

where α and β are preset values within a range that satisfies the range of the above equation.

The smoothing matrix may include a second sub-matrix composed of elements of the smoothing matrix multiplied by columns excluding the columns of extreme outliers from the columns of the input activation matrix X. Here, the second sub-matrix may be a diagonal matrix in which a diagonal element is a second smoothing factor dₖ for outlier mitigation of the columns excluding the columns of extreme outliers, wherein N*+1<=k<=n, where n is the number of columns in the input activation matrix.

According to another aspect of the present disclosure, there is provided an AI model quantization device including: a memory which loads a quantization program; and one or more processors which execute the quantization program. Here, the quantization program may include: an instruction for obtaining an input activation matrix X and a weight matrix W of an AI model; an instruction for sequentially multiplying the obtained input activation matrix X by a permutation matrix P and a smoothing matrix T and obtaining a transformed input activation matrix [symbol] as a result of the matrix multiplication operation; an instruction for sequentially multiplying an inverse matrix T⁻¹ of the smoothing matrix, an inverse matrix P⁻¹ of the permutation matrix and the weight matrix W and obtaining a transformed weight matrix [symbol] as a result of the matrix multiplication operation; an instruction for quantizing the transformed input activation matrix \tilde{X}; an instruction for quantizing the transformed weight matrix [symbol] ; and an instruction for multiplying the quantized transformed input activation matrix by the quantized transformed weight matrix to output a quantized linear transform result of the AI model. The permutation matrix may be a permutation matrix that rearranges columns of extreme outliers, which satisfy a predetermined definition of extreme outliers, among columns of the input activation matrix X to predesignated positions, the smoothing matrix may include a first sub-matrix composed of elements of the smoothing matrix multiplied by the rearranged columns of extreme outliers, and the first sub-matrix may be a lower triangular matrix.

The permutation matrix may be a permutation matrix that rearranges the columns of the input activation matrix X in descending sorted order based on a (maximum element value/mean element value) of each column.

In addition, the first sub-matrix may include a first smoothing factor sⱼₖ (k<=j<=N*) at position (row j, column k) which is determined in consideration of both a maximum value and a mean value of each of columns 1 to N* of the transformed input activation matrix, wherein N* is an index of a last extreme outlier among columns of an input matrix rearranged in descending sorted order.

### BRIEF DESCRIPTION OF THE DRAWINGS

These and/or other aspects will become apparent and more readily appreciated from the following description of the embodiments, taken in conjunction with the accompanying drawings in which:

FIG. 1 is a first configuration diagram of an artificial intelligence (AI) model quantization system according to an embodiment of the present disclosure.

FIG. 2 is a first configuration diagram of a quantization device according to an embodiment of the present disclosure;

FIG. 3 is a second configuration diagram of the AI model quantization system described with reference to FIG. 1;

FIG. 4 is a second configuration diagram of the quantization device described with reference to FIG. 3;

FIG. 5 is a diagram illustrating a process of rearranging columns of extreme outliers, which satisfy a predetermined definition of extreme outliers, among columns of an input activation matrix to predesignated positions in some embodiments of the present disclosure;

FIG. 6 is a diagram illustrating a process of mitigating the extreme outliers by multiplying the input activation matrix having the columns of extreme outliers rearranged to the predesignated positions as described with reference to FIG. 5 by a smoothing matrix;

FIG. 7 is a diagram illustrating a process of mitigating general outliers by multiplying the input activation matrix having the columns of extreme outliers rearranged to the predesignated positions as described with reference to FIG. 5 by the smoothing matrix;

FIG. 8 is a diagram illustrating a process of simultaneously mitigating the extreme outliers and the general outliers as described with reference to FIGS. 6 and 7;

FIGS. 9 and 10 are flowcharts illustrating AI model quantization methods according to embodiments of the present disclosure; and

FIG. 11 illustrates the hardware configuration of a computing system described in some embodiments of the present disclosure.

### DETAILED DESCRIPTION

Hereinafter, embodiments of the present disclosure will be described in further detail with reference to the attached drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the present disclosure to those skilled in the art, and the present disclosure will only be defined by the appended claims. In explanation of the present disclosure, a detailed description might be omitted when it is determined that related prior art or the detailed description of the structure may unnecessarily obscure the point of the present disclosure. Like reference numerals refer to like elements throughout the specification.

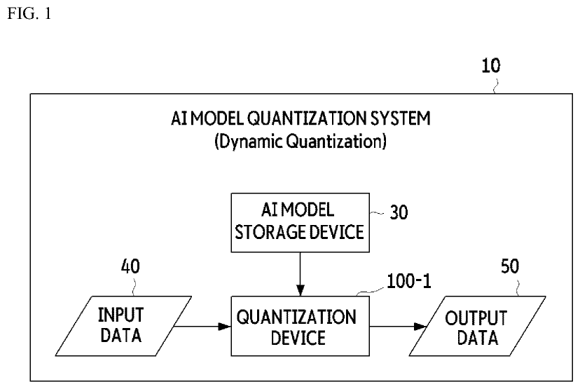

The configuration and operation of artificial intelligence (AI) model quantization systems according to embodiments of the present disclosure will be described with reference to FIGS. 1 through 4.

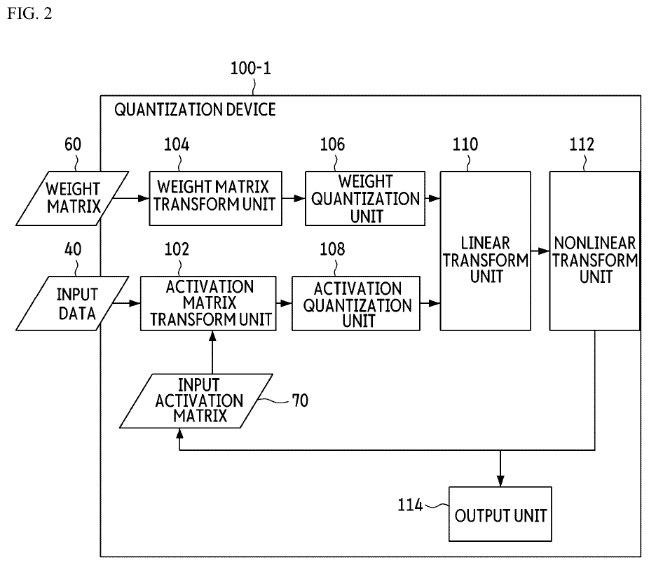

First, an AI model quantization system of a dynamic quantization type will be described with reference to FIGS. 1 and 2. In the present disclosure, it will be understood that dynamic quantization refers to quantization performed during inference, and static quantization refers to quantization performed after training (post-training) and before inference (pre-inference).

In the present disclosure, the target of quantization may be at least one of an activation matrix and a weight matrix.

The activation matrix refers to data input to a specific layer of an AI model and may be obtained by inputting the result of a linear transform of a layer immediately before the specific layer into an activation function. A transform performed using the result of application of the activation function may be understood as a nonlinear transform.

The weight matrix exists for each layer of the AI model. Each layer has a unique weight matrix for performing its operation. The operation of each layer may be understood as the linear transform described above.

In the present disclosure, quantization may be understood as adjusting each element of the activation matrix and/or the weight matrix from high precision to low precision. This quantization technology is a technology that reduces computational speed and memory usage by reducing the precision of an AI model. In the present disclosure, various embodiments in which an increase in quantization error due to quantization is suppressed even when “extreme outliers” are included in the activation matrix will be described.

The extreme outliers may be understood as data that deviates from a center value far more significantly than general outliers. The present disclosure will address a case where the extreme outliers are included in the activation matrix.

In a quantization process of an AI model, such as a deep learning model or a transformer-based large language model (LLM), if outliers are included in the activation matrix of each layer, a quantization interval may become excessively large because an excessively large range relative to the overall data distribution must be covered. This reduces the resolution that can be expressed by most normal values in an integer domain, resulting in increased quantization error and reduced model precision. In particular, when extreme values (extreme outliers) are present, the entire scale range may be determined by a small number of abnormal values, which can lead to a sharp decrease in quantization efficiency.

The AI model quantization system according to the current embodiment can perform quantization of an AI model while suppressing an increase in quantization error due to the quantization even when extreme outliers are included in the activation matrix.

As illustrated in FIG. 1, the AI model quantization system 10 according to the current embodiment may include an AI model storage device 30 and a quantization device 100-1. The AI model storage device 30 is a storage device that stores data of one or more AI models. The data of each AI model may include hyperparameters, such as the number of layers, the number of neurons and activation function of the AI model, and a weight matrix for each layer of the AI model.

The quantization device 100-1 may receive identification information of an AI model to be quantized from a user terminal (not illustrated) or an external system (not illustrated). The quantization device 100 may receive data of the AI model corresponding to the identification information from the AI model storage device 30.

When an inference command using the AI model corresponding to the identification information is received from the user terminal (not illustrated) or the external system (not illustrated), the quantization device 100-1 performs a dynamic quantization operation using input data 40 for inference and the data of the AI model. As described above, even if extreme outliers are included in an activation matrix of each layer formed from the input data 40, a quantization error in quantization performed by the quantization device 100-1 is suppressed.

To this end, the quantization device 100-1 sequentially multiplies an input activation matrix X by a permutation matrix P and a smoothing matrix T and obtains a transformed input activation matrix [symbol] as a result of the matrix multiplication operation. In addition, the quantization device 100-1 sequentially multiplies an inverse matrix T⁻¹ of the smoothing matrix T, an inverse matrix P⁻¹ of the permutation matrix P and a weight matrix W together and obtains a transformed weight matrix [symbol] as a result of the matrix multiplication operation. This will be described with reference to Equation 1 below.

Y=X·W=(XPT)·(T⁻¹P⁻¹W) (1).

When the input activation matrix X input to a specific layer of the AI model and the weight matrix W of the specific layer are obtained, if a linear transform of the specific layer is defined as the matrix multiplication of the input activation matrix X and the weight matrix W, it may be understood that the result of the linear transform is a matrix Y.

In the present disclosure, in order to solve the problem of increased quantization error due to extreme outliers and (general) outliers included in the input activation matrix X, the input activation matrix X is transformed to obtain the transformed input activation matrix [symbol] , and the weight matrix W is transformed to obtain the transformed weight matrix \tilde{W}. In Equation 1 above, it can be understood that the transformed input activation matrix [symbol] is the matrix product of X, P and T, and the transformed weight matrix [symbol] is the matrix product of T⁻¹, P⁻¹, and W.

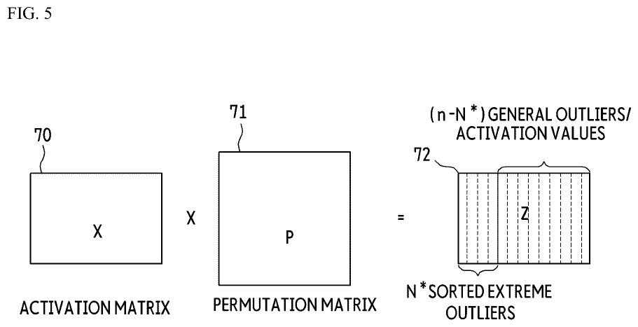

P is a permutation matrix that rearranges columns of extreme outliers, which satisfy a predetermined definition of extreme outliers, among columns of the input activation matrix X to predesignated positions. P⁻¹ is an inverse matrix of P. Due to the nature of the permutation matrix, P⁻¹=PT (transposed matrix of P). P will be described in more detail with reference to FIG. 5.

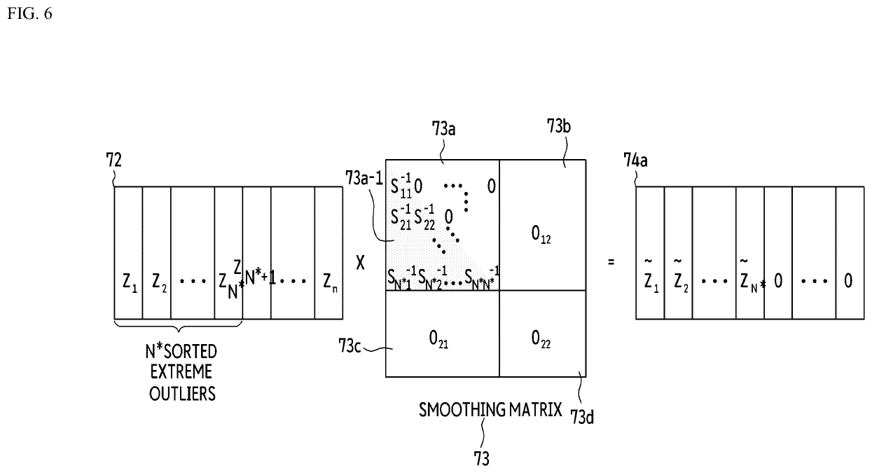

T may be a smoothing matrix including a first sub-matrix and a second sub-matrix. The first sub-matrix is composed of elements of the smoothing matrix multiplied by the rearranged columns of extreme outliers. The second sub-matrix is a diagonal matrix in which a diagonal element is a second smoothing factor for outlier mitigation of the other columns. T will be described in more detail with reference to FIGS. 6 through 8.

The transformed input activation matrix [symbol] has outliers mitigated to be robust to extreme outliers during a quantization process, and the transformed weight matrix [symbol] also has outliers mitigated to be robust to the extreme outliers during the quantization process. Therefore, the AI model quantization system 10 can suppress an increase in quantization error despite the extreme outliers by quantizing the transformed input activation matrix [symbol] and the transformed weight matrix [symbol] .

The following equation is provided to explain an example quantization method. Equation 2 expresses a process of quantizing high-bit original data X in floating point format into low-bit integer data X_{INTN} by dividing the high-bit original data X by a smoothing factor Δ and adding a zero point z∈Z to the division result.

$${X}_{INTN} = round ( \frac{X}{Δ} ) + z ,$$

$$where$$

$$Δ = \frac{max ( X ) - min ( X )}{{2}^{N} - 1} and z = - round ( \frac{min ( X )}{Δ} )$$

The extreme outliers described above will be described again below.

Let us assume that the result of dequantizing quantized data to the original precision is [symbol] . Equation 3 below is derived from Equation 2.

$$\hat{X} = ( {X}_{I N T N} - z ) \times Δ . \qquad ( 3 )$$

Then, a quantization error is generally ∥X− [symbol] ∥. The original data X is smoothed by a factor, which is dependent on max (X)-min (X), into a value within an N-bit integer data representation range. This means that the more extreme the outlier is for an individual quantization application unit (tensor, token, channel, etc.), the larger the rounding-off error of a normal value may be. Therefore, outliers, which are very large in size and distributed in small numbers as outliers existing in an individual quantization application unit, may cause a large quantization error. This type of outlier is referred to as extreme outlier in the present disclosure.

As described above, in the present disclosure, extreme outliers may satisfy a predetermined definition and may be automatically identified according to clear criteria.

The configuration and operation of the quantization device 100-1 described with reference to FIG. 1 will be described in more detail with reference to FIG. 2. The quantization device 100-1 of FIG. 2 may be understood as a device that performs quantization at the time of inference.

A weight matrix transform unit 104 receives a weight matrix 60 and generates a transformed weight matrix [symbol] as described above.

An activation matrix transform unit 102 receives input data 40 (if a current layer is a first layer) or receives an input activation matrix 70, which is the result of a nonlinear transform of an immediately previous layer, from a nonlinear transform unit 112 and generates a transformed input activation matrix [symbol] as described above. In some embodiments, the activation matrix transform unit 102 may receive the result of a linear transform of the immediately previous layer as it is. That is, after the linear transform, the immediately previous layer may output data to the current layer as it is without applying an activation function. In this case, unlike in FIG. 2, the activation matrix transform unit 102 may receive the input activation matrix 70, which is the result of the linear transform of the immediately previous layer, from a linear transform unit 110 of the immediately previous layer.

In addition, the linear transform unit 110 may perform a linear transform operation of the current layer. A first input to the linear transform operation may be a transformed input activation matrix quantized by an activation quantization unit 108, and a second input may be a transformed weight matrix quantized by a weight quantization unit 106.

The linear transform unit 110 may provide the result of the linear transform operation of the current layer to the nonlinear transform unit 112. The nonlinear transform unit 112 may input the result of the linear transform operation to a predesignated activation function and output the result of a nonlinear transform of the current layer, which is also the activation matrix 70 of a next layer. If the current layer is a last hidden layer of an AI model, an output value of the activation function may be output by an output unit 114.

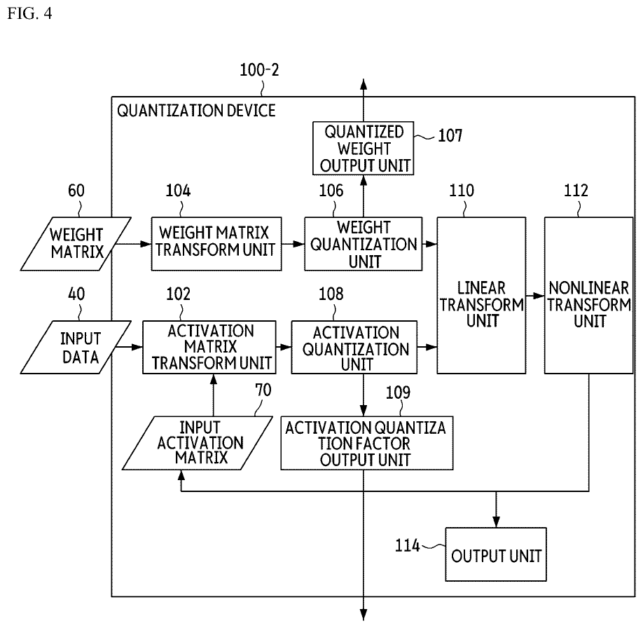

The AI model quantization system of the present disclosure may also perform static quantization after training (post-training). As described above, a quantization device 100-2 which performs static quantization receives calibration data 50, which is a type of sample data. As a result, as illustrated in FIG. 4, a weight matrix transform unit 104 of the quantization device 100-2 receives a weight matrix 60 and generates a transformed weight matrix W as described above. An activation matrix transform unit 102 receives the calibration data 50 (if a current layer is a first layer) or receives an input activation matrix 70, which is the result of a nonlinear transform of an immediately previous layer, from a nonlinear transform unit 112 and generates a transformed input activation matrix [symbol] as described above.

As described above, in some embodiments, the activation matrix transform unit 102 may receive the result of a linear transform of the immediately previous layer as it is. In this case, unlike in FIG. 4, the activation matrix transform unit 102 may receive the input activation matrix 70, which is the result of the linear transform of the immediately previous layer, from a linear transform unit 110 of the immediately previous layer.

Unlike the quantization device 100-1 of the dynamic quantization type described with reference to FIG. 2, the quantization device 100-2 of the static quantization type illustrated in FIG. 4 may further include a quantized weight output unit 107 which outputs a quantized weight matrix provided from a weight quantization unit 106 and an activation quantization factor output unit 109 which outputs an activation quantization factor provided from an activation quantization unit 108.

The activation quantization factor output unit 109 may generate and output an activation quantization factor, which includes a smoothing factor Δ and a zero point z as described with reference to Equation 2, by using a quantized activation matrix.

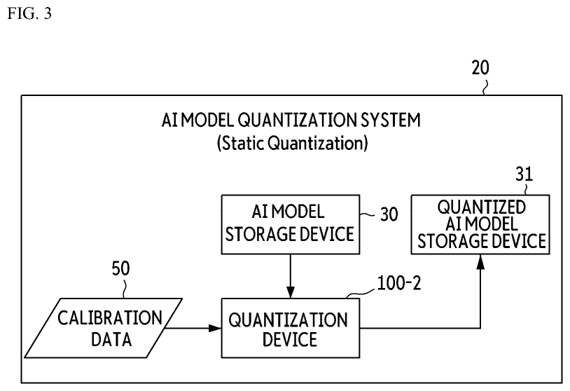

The quantized weight matrix and the activation quantization factor may be stored in a quantized AI model storage device 31 illustrated in FIG. 3. That is, the result of static quantization of an AI model to be quantized is stored in the quantized AI model storage device 31. Then, at a later inference time, fast calculation is possible using the quantized weight matrix and the activation quantization factor stored in the quantized AI model storage device 31 without the need to perform quantization.

A process of rearranging columns of extreme outliers included in an activation matrix X to predesignated positions by multiplying the activation matrix X by the permutation matrix P described above will now be described with reference to FIG. 5.

As is widely known, a permutation matrix is a binary matrix generated by permuting rows or columns of an identity matrix in a specific order. The permutation matrix has exactly one entry of 1 in each row and each column with all other entries of 0. The permutation matrix performs the function of rearranging the order of rows or columns of a target matrix through a matrix multiplication operation. In the present disclosure, the permutation matrix rearranges columns of extreme outliers included in an input activation matrix X to predesignated positions. How the permutation matrix is constructed based on the value of each element of the input activation matrix X will be described below. The constructing of the permutation matrix may be performed by, for example, the activation matrix transform unit 102 described with reference to FIGS. 2 and 4.

First, the activation matrix transform unit 102 may rearrange columns of an input activation matrix X in descending sorted order based on a (maximum element value/mean element value) of each column. Here, the maximum element value may be a maximum value among absolute values of element values. In addition, the mean element value may be a mean value of the absolute values of the element values. The more extreme the outlier, the larger the (maximum element value/mean element value) is likely to be. Therefore, if the columns of the input activation matrix X are rearranged in descending sorted order based on the (maximum element value/mean element value) of each column, there is a high possibility that extreme outliers will be positioned in leading columns of the rearranged input activation matrix X.

In some embodiments, in order to reduce the amount of computation, the activation matrix transform unit 102 may rearrange only top N columns among the columns of the input activation matrix X in descending sorted order based on the (maximum element value/mean element value) of each column. In this case, the top N columns may be top N columns whose maximum element values are large among the columns of the input activation matrix X.

A permutation matrix 71 may be used to rearrange the columns of the input activation matrix X in descending sorted order based on the (maximum element value/mean element value) of each column as described above or may be used to rearrange top N columns among the columns of the input activation matrix X in descending sorted order based on the (maximum element value/mean element value) of each column.

In addition, the activation matrix transform unit 102 may identify extreme outliers. Here, the extreme outliers may be defined as [columns 1 to N* of an input matrix rearranged in descending sorted order]. Here, N* may be a first j (j>=1) that satisfies the following equation.

(Maximum element value/mean element value) of column j/(maximum element value/mean element value) of column (j+1)<=reference value (4).

The reference value in Equation 4 above may be a user-set value. For example, if the reference value is 1.1, when columns of an activation matrix are sorted in descending order based on the (maximum element value/mean element value) as described above, the first j where the (maximum element values/mean element values) of a j^{th} column and a (j+1)th column fall below 10% (whose (maximum element value/mean element value) is greater than the (maximum element value/mean element value of a (j+1)th column by more than 10%) may be determined as N*. For example, if N* is 4, first through fourth columns will be extreme outliers. Since extreme outliers will be greatly different from a normal numerical range, the ratio of the (maximum element value/mean element value) of a column corresponding to an extreme outlier to the (maximum element value/mean element value) of a next column will be equal to or greater than the reference value. It can be understood that Equation 4 determines a last column (i.e., N*) corresponding to an extreme outlier in an input matrix rearranged in descending sorted order by using this point.

FIG. 5 illustrates a matrix Z (72) in which the columns of the activation matrix X (70) are sorted in descending order based on the (maximum element value/mean element value) by multiplying the activation matrix X (70) by the permutation matrix P (71). In the matrix Z (72), N* extreme outliers sorted in descending order and other general outliers or activation values are rearranged to different positions.

FIG. 6 is a diagram for explaining a first sub-matrix 73a composed of elements of a smoothing matrix 73 multiplied by N* sorted extreme outliers arranged as leading columns of the matrix Z (72).

The first sub-matrix 73a is a lower triangular matrix. Each non-zero element value 73a-1 included in the first sub-matrix 73a includes a first smoothing factor sⱼₖ (k<=j<=N*) at position (row j, column k) which is determined in consideration of both a maximum value and a mean value of each of columns 1 to N* of the transformed input activation matrix (where N* is an index of a last extreme outlier among columns of an input matrix rearranged in descending sorted order).

As shown in Equation 5 below, for a column index k∈[1, N*], \tilde{z}ₖ is calculated as a weighted sum of k^{th} through N*^{th} columns of the matrix Z. Among the extreme outliers, an extreme outlier greatly different from a normal value will be in a leading column among the columns of the matrix Z.

Equation 5 calculates a weighted sum of an extreme outlier located in a more leading column among the columns of the matrix Z with more subsequent columns. Therefore, it presents a unique technical spirit of the present disclosure that maximizes the outlier mitigation effect by calculating the weighted sum of an extreme outlier having a greater difference from the normal value among the extreme outliers with more subsequent columns.

$${\tilde{z}}_{k} = {{\sum }^{{N}^{*}}}_{j = k} \frac{{z}_{j}}{{s}_{jk}} , for 1 \leq k \leq {N}^{⋆} . \qquad ( 5 )$$

It may be understood that the first smoothing factor sⱼₖ is a value that satisfies Equation 6 below for calibration data of the input activation matrix X, and α and β are preset values within a range that satisfies the range of the above equation. Since extreme outliers are distributed in very small numbers, a gap between a maximum absolute value and a mean absolute value is large. Therefore, the first smoothing factor sⱼₖ may be defined in consideration of both the maximum absolute value and the mean absolute value, so that the extreme outliers can be mitigated.

sⱼₖ=max(|zⱼ|)^{α}mean(|zⱼ|)^{β}, for k≤j≤N*, where(α,β)∈[0,1]×[0,1] and 0<α+β<1 s.t. min ∥X− [symbol] ∥.(X is the quantization result of X) (6).

The first sub-matrix 73a of FIG. 6 is used to calculate \tilde{z}ₖ according to Equation 5. It can be understood that each non-zero element included in the first sub-matrix 73a is expressed in a form such as s11⁻¹ to express that each column of the matrix Z is divided by the first smoothing factor sⱼₖ in Equation 5.

FIG. 6 illustrates a matrix 74a composed of 2k corresponding to extreme outliers as a result of multiplying the matrix Z (72) by the smoothing matrix 73.

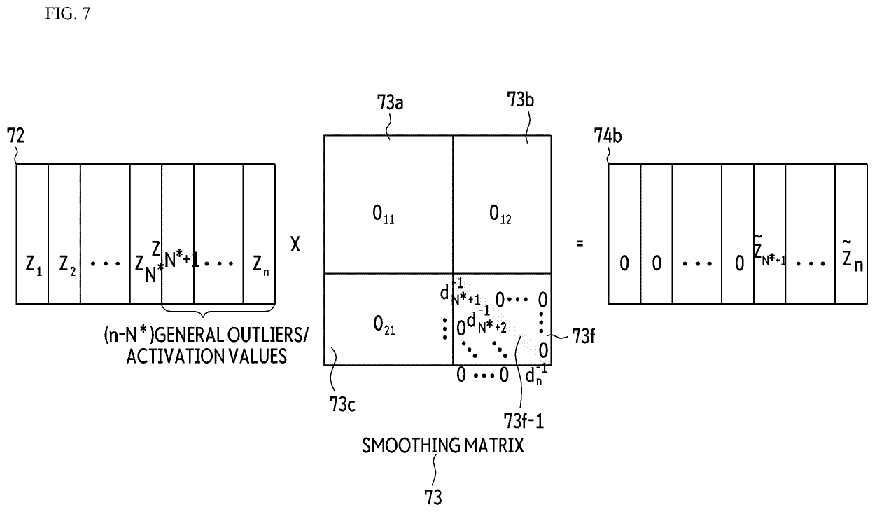

Next, a description will be given with reference to FIG. 7.

FIG. 7 illustrates outlier mitigation performed using a second smoothing factor dₖ for columns of general outliers and columns of normal activation values (non-outliers) Z_{N*+1} to Zₙ (where n is the number of columns in an activation matrix). The outlier mitigation using the second smoothing factor dₖ is expressed in Equation 7 below.

$${\tilde{Z}}_{k} = \frac{{Z}_{k}}{{d}_{k}} , for {N}^{*} + 1 \leq k \leq n . \qquad ( 7 )$$

For the outlier mitigation of the columns Z_{N*+1} to Zₙ, the columns Z_{N*+1} to Zₙ are divided by the second smoothing factor, and the division result is expressed as Žk.

A second sub-matrix 73f-1 illustrated in FIG. 7 is a diagonal matrix in which a diagonal element is the second smoothing factor dₖ for outlier mitigation of the columns Z_{N*+1} to Zₙ (N*+1<=k<=n, where n is the number of columns in an input activation matrix). The second sub-matrix 73f-1 of FIG. 7 is used to calculate Žk according to Equation 7. It can be understood that each non-zero element included in the second sub-matrix 73f-1 is expressed in a form such as d_{N*+1}⁻¹ to express that each column of the matrix Z is divided by the second smoothing factor dₖ in Equation 7.

The columns Z_{N*+1} to Zₙ may be multiplied by the second sub-matrix 73f-1 to produce a matrix \tilde{Z} (74b) illustrated in FIG. 7.

The second smoothing factor dₖ may be a value determined by Equation 8 below. In addition, γ may be a value determined to minimize a quantization error formed as a result of quantization performed according to the input of calibration data.

dₖ=mean(|zₖ|)^{γ}, for N*+1≤k≤n (8).

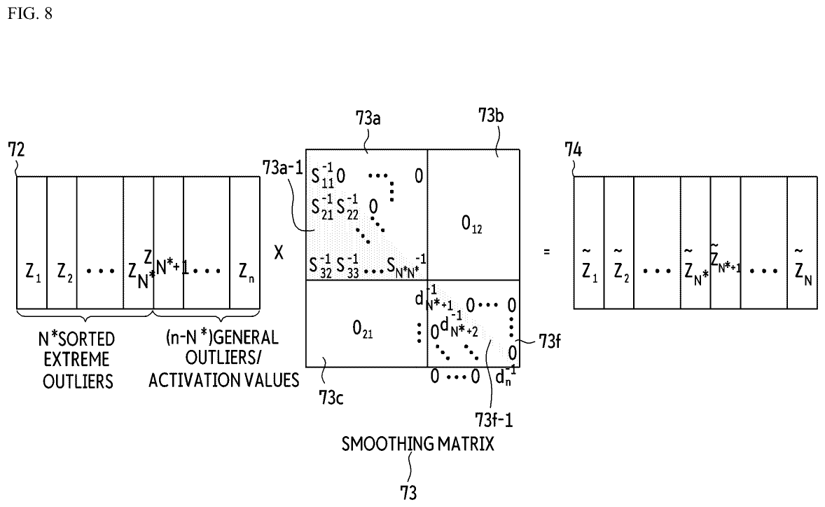

So far, the first sub-matrix 73a for outlier mitigation of extreme outliers and the second sub-matrix 73f for outlier mitigation of outliers and normal activation values have been described with reference to FIGS. 6 and 7. In FIG. 8, the matrix Z (72) is multiplied by a smoothing matrix composed of the first sub-matrix 73a, the second sub-matrix 73f, and zero matrices 73c and 73b to produce a matrix Źₖ (74), so that the extreme outliers included in the activation matrix are mitigated in the manner shown in Equation 5, and the general outliers included in the activation matrix are mitigated in the manner shown in Equation (7).

The transformed input activation matrix [symbol] of the present disclosure may be understood as being identical to the matrix \tilde{Z}ₖ (74).

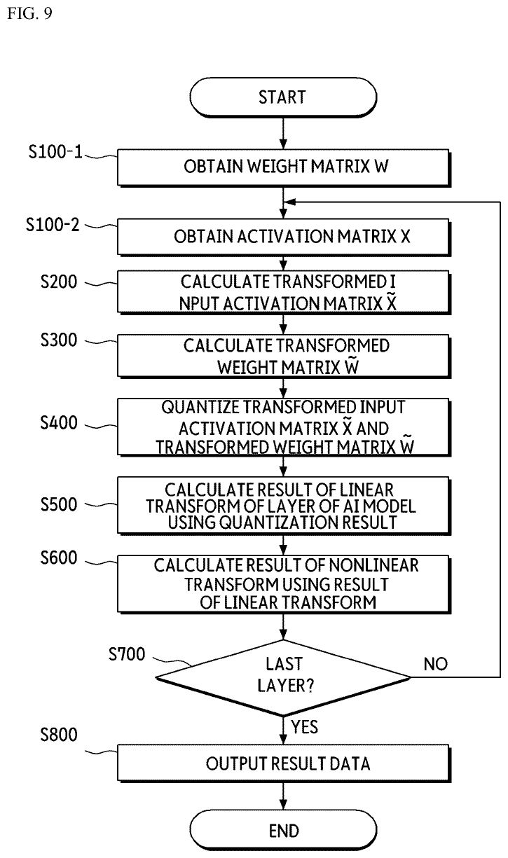

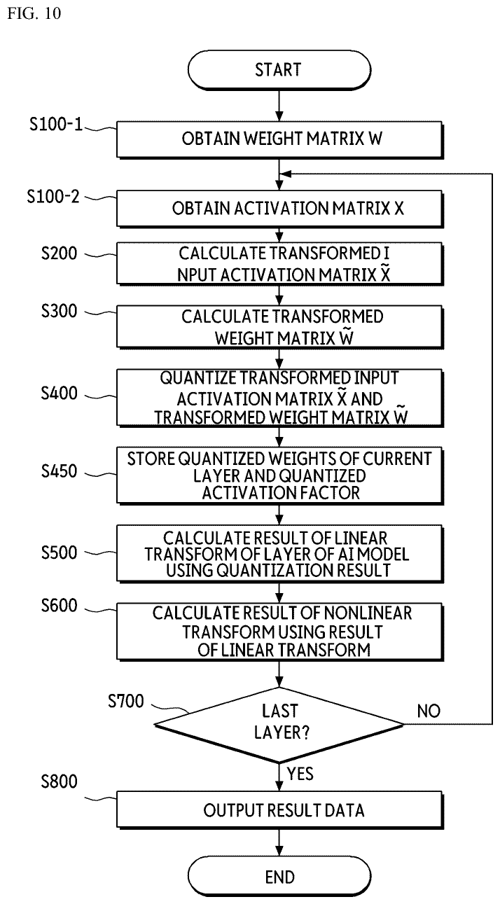

Next, AI model quantization methods according to embodiments of the present disclosure will be described with reference to FIGS. 9 and 10. The quantization methods according to the current embodiments may be performed by a computing device. Some operations may be performed by a first computing device, and other operations may be performed by a second computing device. In addition, although not specifically described, the technical spirit of the quantization system according to the above-described embodiment can naturally be applied to the quantization methods according to the current embodiments.

Next, an AI model quantization method according to an embodiment of the present disclosure will be described with reference to FIG. 9. The quantization method according to the current embodiment may be performed by one or more computing systems. In addition, the quantization method according to the current embodiment may have some operations performed by a first computing device and the other operations performed by a second computing device. For example, some operations of the quantization method according to the current embodiment may be performed by a first server, and the other operations may be performed by a second server. When the subject of each operation is omitted, it will be understood that the operations are performed by the computing systems. In addition, it should be noted that the embodiments related to the quantization system described with reference to FIGS. 1 through 8 can naturally be applied to the quantization method according to the current embodiment, even if not mentioned.

The quantization method according to the current embodiment begins with obtaining an input activation matrix X and a weight matrix W (operations S100-1 and S100-2). The input activation matrix X refers to data input to a specific layer of an AI model, and the weight matrix W includes unique weight values for an operation of each layer.

Next, a transformed input activation matrix [symbol] is calculated (operation S200). The transformed input activation matrix [symbol] is obtained by sequentially multiplying the input activation matrix X by a permutation matrix P and a smoothing matrix T. The permutation matrix P rearranges extreme outliers, and the smoothing matrix T mitigates the influence of these outliers.

Next, a transformed weight matrix [symbol] is calculated (operation S300). The transformed weight matrix [symbol] may be obtained by sequentially multiplying an inverse matrix T⁻¹ of the smoothing matrix T, an inverse matrix P⁻¹ of the permutation matrix P, and the weight matrix W.

Each of the transformed input activation matrix [symbol] and the transformed weight matrix [symbol] is quantized (operation S400). This quantization process is performed to reduce memory usage and improve computational efficiency.

The result of a linear transform of the layer of the AI model is calculated using the quantization result (operation S500). The result of the linear transform leads to the result of a nonlinear transform (operation S600), and the result of the nonlinear transform is used as input to a next layer as the activation matrix described above.

Next, it is checked whether the current layer is a last layer of the AI model (operation S700). If so, final result data is output (operation S800). The last layer may refer to a last hidden layer. If the current layer is not the last layer of the AI model, an operation of the next layer is performed.

In this way, the quantization method according to the current embodiment helps to reduce resource consumption while maintaining performance by efficiently quantizing the AI model.

Next, a static AI model quantization method according to an embodiment of the present disclosure will be described with reference to FIG. 10. The static quantization method according to the current embodiment may be performed by one or more computing systems. This method may be performed in advance, and the quantization result may be stored to enable fast inference later.

In the current embodiment, a quantization device obtains an input activation matrix X and a weight matrix W (operations S100-1 and S100-2) and then calculates a transformed input activation matrix [symbol] and a transformed weight matrix [symbol] (operations S200 and S300). These operations are similar to those of the method described in FIG. 9. However, in static quantization, an activation quantization factor is set in advance using sample data (calibration data).

Next, the quantization device quantizes the transformed matrices [symbol] and \tilde{W} (operation S400) and stores quantized weights of a current layer and an activation factor (operation S450). The stored information enables fast calculation later and makes it possible to reduce resource consumption while maintaining the performance of an AI model.

Next, the quantization device calculates the result of a linear transform of the layer of the AI model using the quantization result (operation S500) and then calculates the result of a nonlinear transform (operation S600).

The quantization device checks whether the current layer is a last layer of the AI model (operation S700) and then outputs final result data (operation S800). If the current layer is not the last layer of the AI model, the quantization device continues to perform an operation of a next layer.

Through the static quantization, the current embodiment reduces computational burden at the time of inference and enables efficient model operation.

The methods according to the embodiments of the present disclosure described so far can be performed by the execution of a computer program implemented as computer-readable code. The computer program may be transmitted from a first computing device to a second computing device through a network such as the Internet and may be installed in the second computing device and thus used in the second computing device.

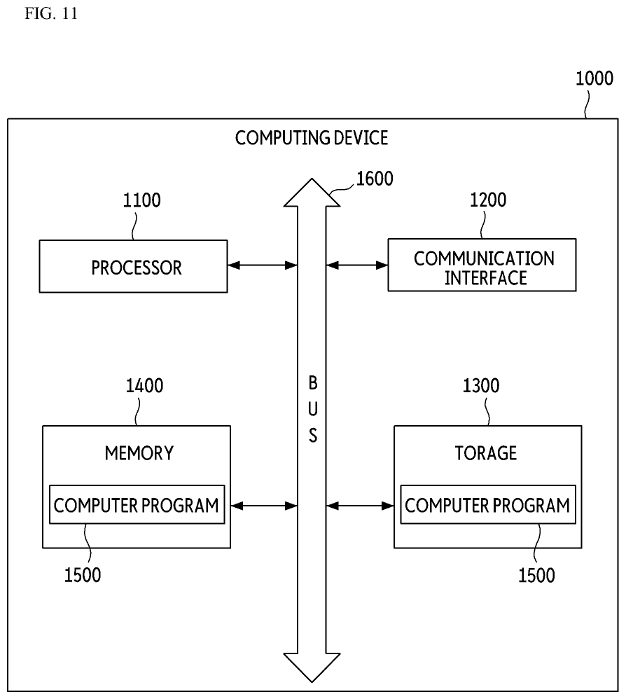

FIG. 11 illustrates the hardware configuration of a computing device presented in some embodiments of the present disclosure. A computing system 1000 of FIG. 11 may include one or more processors 1100, a system bus 1600, a communication interface 1200 connected to a purchaser terminal, a memory 1400 which loads a computer program 1500 to be executed by the processors 1100, and a storage 1300 which stores the computer program 1500.

The processors 1100 control the overall operation of each element of the computing system 1000. The processors 1100 may perform an operation on at least one application or program for executing methods/operations according to various embodiments of the present disclosure. In addition, the processors 1100 may include a plurality of processors. At least some of the processors may be graphic processing units (GPUs) which provide high floating point computational performance and high convolutional computational performance.

The memory 1400 stores various data, commands and/or information. The memory 1400 may load one or more computer programs 1500 from the storage 1300 in order to execute the methods/operations according to the various embodiments of the present disclosure. The storage 1300 may non-temporarily store the programs 1500.

A computer program 1500 may include one or more instructions which implement the methods/operations according to the various embodiments of the present disclosure. When the computer program 1500 is loaded into the memory 1400, the processors 1100 may perform the methods/operations according to the various embodiments of the present disclosure by executing the instructions.

The computer program 1500 may include an instruction for obtaining an input activation matrix X and a weight matrix W of an AI model, an instruction for sequentially multiplying the obtained input activation matrix X by a permutation matrix P and a smoothing matrix T and obtaining a transformed input activation matrix [symbol] as a result of the matrix multiplication operation, an instruction for sequentially multiplying an inverse matrix T⁻¹ of the smoothing matrix T, an inverse matrix P⁻¹ of the permutation matrix P and the weight matrix W and obtaining a transformed weight matrix [symbol] as a result of the matrix multiplication operation, an instruction for quantizing the transformed input activation matrix [symbol] , an instruction for quantizing the transformed weight matrix [symbol] , an instruction for multiplying the quantized transformed input activation matrix by the quantized transformed weight matrix to output a quantized linear transform result of the AI model.

The permutation matrix may be a permutation matrix that rearranges columns of extreme outliers, which satisfy a predetermined definition of extreme outliers, among columns of the input activation matrix X to predesignated positions.

The smoothing matrix may include a first sub-matrix composed of elements of the smoothing matrix multiplied by the rearranged columns of extreme outliers. The first sub-matrix may be a lower triangular matrix.

In addition, the computer program 1500 may further include an instruction for storing a quantized AI model in the storage 1300 by storing the quantized transformed weight matrix for each layer of an AI model to be quantized. In addition, the computer program 1500 may further include an instruction for storing, for each layer of the AI model to be quantized, an activation quantization factor determined based on the quantized transformed input activation matrix of the input activation matrix input to the layer. The activation quantization factor may include a smoothing factor Δ and a zero point z. A description of the activation quantization factor can be found in the description given with reference to FIG. 4. The activation quantization factor may be calculated by inputting calibration data to the AI model.

Static quantization technology that has low precision but suppresses an increase in quantization error due to extreme outliers by storing the quantized AI model and the activation quantization factor in advance can be provided.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

While the present disclosure has been particularly shown and described with reference to embodiments thereof, it will be understood by those of ordinary skill in the art that various changes in form and details may be made therein without departing from the spirit and scope of the present disclosure as defined by the following claims. The embodiments should be considered in a descriptive sense only and not for purposes of limitation. Therefore, the scope of the present disclosure is defined not by the detailed description of the present disclosure but by the following claims, and all differences within the scope will be construed as being included in the present disclosure.

What is claimed is:

1. An artificial intelligence (AI) model quantization method performed by a computing system and comprising:
obtaining an input activation matrix X and a weight matrix W of an AI model;
sequentially multiplying the obtained input activation matrix X by a permutation matrix P and a smoothing matrix T and obtaining a transformed input activation matrix [symbol] as a result of the matrix multiplication operation;
sequentially multiplying an inverse matrix T⁻¹ of the smoothing matrix, an inverse matrix P⁻¹ of the permutation matrix and the weight matrix W and obtaining a transformed weight matrix [symbol] as a result of the matrix multiplication operation;
quantizing the transformed input activation matrix [symbol] ;
quantizing the transformed weight matrix [symbol] ; and
multiplying the quantized transformed input activation matrix by the quantized transformed weight matrix to output a quantized linear transform result of the AI model,
wherein the permutation matrix is a permutation matrix that rearranges columns of extreme outliers, which satisfy a predetermined definition of extreme outliers, among columns of the input activation matrix X to predesignated positions, the smoothing matrix comprises a first sub-matrix comprised of elements of the smoothing matrix multiplied by the rearranged columns of extreme outliers, and the first sub-matrix is a lower triangular matrix.

2. The method of claim 1, wherein the permutation matrix is a permutation matrix that rearranges the columns of the input activation matrix X in descending sorted order based on a (maximum element value/mean element value) of each column.

3. The method of claim 2, wherein the permutation matrix is a permutation matrix that rearranges only top N columns among the columns of the input activation matrix X in descending sorted order based on the (maximum element value/mean element value) of each column.

4. The method of claim 3, wherein the top N columns are top N columns whose maximum element values are large among the columns of the input activation matrix X.

5. The method of claim 2, wherein the predetermined definition of extreme outliers is [columns 1 to N* of an input matrix rearranged in descending sorted order], wherein N* is a first j (j>=1) that satisfies the following equation:
(Maximum element value/mean element value) of column j/(maximum element value/mean element value) of column (j+1)<=reference value.

6. The method of claim 1, wherein the first sub-matrix comprises a first smoothing factor sⱼₖ (k<=j<=N*) at position (row j, column k) which is determined in consideration of both a maximum value and a mean value of each of columns 1 to N* of the transformed input activation matrix, wherein N* is an index of a last extreme outlier among columns of an input matrix rearranged in descending sorted order.

7. The method of claim 6, wherein the first smoothing factor sⱼₖ is a value that satisfies the following equation for calibration data of the input activation matrix X:
sⱼₖ=max(|zⱼ|)^{α}mean(|zⱼ|)^{β}, for k≤j≤N*, where(α,β)∈[0,1]×[0,1] and 0<α+β<1 s.t. min ∥X− [symbol] ∥.(X is the quantization result of X)
where α and β are preset values within a range that satisfies the range of the above equation.

8. The method of claim 6, wherein the smoothing matrix comprises a second sub-matrix comprised of elements of the smoothing matrix multiplied by columns excluding the columns of extreme outliers from the columns of the input activation matrix X, and the second sub-matrix is a diagonal matrix in which a diagonal element is a second smoothing factor dₖ for outlier mitigation of the columns excluding the columns of extreme outliers, wherein N*+1<=k<=n, where n is the number of columns in the input activation matrix.

9. An AI model quantization device comprising:
a memory which loads a quantization program; and
one or more processors which execute the quantization program,
wherein the quantization program comprises:
an instruction for obtaining an input activation matrix X and a weight matrix W of an AI model;
an instruction for sequentially multiplying the obtained input activation matrix X by a permutation matrix P and a smoothing matrix T and obtaining a transformed input activation matrix \tilde{X} as a result of the matrix multiplication operation;
an instruction for sequentially multiplying an inverse matrix T⁻¹ of the smoothing matrix, an inverse matrix P⁻¹ of the permutation matrix and the weight matrix W and obtaining a transformed weight matrix [symbol] as a result of the matrix multiplication operation;
an instruction for quantizing the transformed input activation matrix [symbol] ;
an instruction for quantizing the transformed weight matrix [symbol] ; and
an instruction for multiplying the quantized transformed input activation matrix by the quantized transformed weight matrix to output a quantized linear transform result of the AI model,
wherein the permutation matrix is a permutation matrix that rearranges columns of extreme outliers, which satisfy a predetermined definition of extreme outliers, among columns of the input activation matrix X to predesignated positions, the smoothing matrix comprises a first sub-matrix comprised of elements of the smoothing matrix multiplied by the rearranged columns of extreme outliers, and the first sub-matrix is a lower triangular matrix.

10. The device of claim 9, wherein the permutation matrix is a permutation matrix that rearranges the columns of the input activation matrix X in descending sorted order based on a (maximum element value/mean element value) of each column.

11. The device of claim 10, wherein the permutation matrix is a permutation matrix that rearranges only top N columns among the columns of the input activation matrix X in descending sorted order based on the (maximum element value/mean element value) of each column.

12. The device of claim 11, wherein the top N columns are top N columns whose maximum element values are large among the columns of the input activation matrix X.

13. The device of claim 10, wherein the predetermined definition of extreme outliers is [columns 1 to N* of an input matrix rearranged in descending sorted order], wherein N* is a first j (j>=1) that satisfies the following equation:
(Maximum element value/mean element value) of column j/(maximum element value/mean element value) of column (j+1)<=reference value.

14. The device of claim 9, wherein the first sub-matrix comprises a first smoothing factor sⱼₖ (k<=j<=N*) at position (row j, column k) which is determined in consideration of both a maximum value and a mean value of each of columns 1 to N* of the transformed input activation matrix, wherein N* is an index of a last extreme outlier among columns of an input matrix rearranged in descending sorted order.

15. The device of claim 14, wherein the first smoothing factor sⱼₖ is a value that satisfies the following equation for calibration data of the input activation matrix X:
sⱼₖ=max(|zⱼ|)^{α}mean(|zⱼ|)^{β}, for k≤j≤N*, where (α,β)∈[0,1]×[0,1] and 0<α+β<1 s.t. min ∥X− [symbol] ∥.(X is the quantization result of X),
where α and β are preset values within a range that satisfies the range of the above equation.

16. The device of claim 14, wherein the smoothing matrix comprises a second sub-matrix comprised of elements of the smoothing matrix multiplied by columns excluding the columns of extreme outliers from the columns of the input activation matrix X, and the second sub-matrix is a diagonal matrix in which a diagonal element is a second smoothing factor dₖ for outlier mitigation of the columns excluding the columns of extreme outliers, wherein N*+1<=k<=n, where n is the number of columns in the input activation matrix.
